(19) United States
(12) Patent Application Publication
(10) Pub. No.: US 2015/0301460 A1
(43) Pub. Date: Oct. 22, 2015

(54) ELECTROPHOTOGRAPHIC PHOTORECEPTOR AND IMAGE FORMING APPARATUS EMPLOYING SAME

(71) Applicant: KYOCERA CORPORATION, Kyoto-shi, kyoto (JP)

(72) Inventor: Yoshiaki FUJIWARA, Kyoto-shi (JP)

(73) Assignee: KYOCERA CORPORATION, Kyoto-shi, Kyoto (JP)

(21) Appl. No.: 14/647,152

(22) PCT Filed: Nov. 25, 2013
(86) PCT No.: PCT/JP2013/081676

§ 371 Date: May 26, 2015

(30) Foreign Application Priority Data
Nov. 30, 2012 (JP) 2012-262187

(51) Int. Cl. G03G 15/00

(52) U.S. Cl. CPC G03G 5/043

(57) ABSTRACT

There is provided an electrophotographic photoreceptor whose surface layer does not easily become thin in use of the electrophotographic photoreceptor, so that occurrence of image defects such as image non-uniformity can be avoided. An electrophotographic photoreceptor includes a cylindrical substrate; a photosensitive layer formed on the cylindrical substrate, the photosensitive layer including at least a photoconductive layer; and a surface layer formed on the photosensitive layer. The surface layer contains amorphous carbon, and has a ratio of an integrated intensity of D band to an integrated intensity of G band in a Raman spectrum of the surface layer being 0.86 or higher and 1.23 or lower. There is realized an electrophotographic photoreceptor whose surface layer does not easily become thin in use of the electrophotographic photoreceptor, so that occurrence of image defects such as image non-uniformity can be prevented.

### TECHNICAL FIELD

The present invention relates to an electrophotographic photoreceptor and an image forming apparatus employing the same.

### BACKGROUND ART

In the conventional art, as described in Japanese Unexamined Patent Publication JP-A 63-129348(1988) or the like, an electrophotographic photoreceptor is fabricated by forming a photoconductive layer, a surface layer, and the like as deposited films onto the surface of a substrate having a cylindrical shape or the like. As a formation method for the deposited films, a method (a plasma CVD method) is widely adopted that a decomposition product obtained when raw material gas is decomposed by high-frequency glow discharge is adhered to a substrate.

Nevertheless, in such an electrophotographic photoreceptor, in some cases, the surface layer is worn out in use so as to become excessively thin and, as a result, the electrostatic charging property of the electrophotographic photoreceptor is degraded so that image defects such as image non-uniformity occur.

### SUMMARY OF INVENTION

### Technical Problem

An object of the invention is to provide an electrophotographic photoreceptor whose surface layer does not easily become thin in use of the electrophotographic photoreceptor, so that occurrence of image defects such as image non-uniformity can be avoided.

### Solution to Problem

An electrophotographic photoreceptor of the invention provides includes: a cylindrical substrate; a photosensitive layer formed on the cylindrical substrate, the photosensitive layer including at least a photoconductive layer; and a surface layer formed on the photosensitive layer, wherein the surface layer contains amorphous carbon, and has a ratio of an integrated intensity of D band to an integrated intensity of G band in a Raman spectrum of the surface layer being 0.86 or higher and 1.23 or lower.

An image forming apparatus of the invention includes the above-mentioned electrophotographic photoreceptor.

### Advantageous Effects of Invention

According to the electrophotographic photoreceptor of the invention, there is realized an electrophotographic photoreceptor whose surface layer does not easily become thin in use of the electrophotographic photoreceptor, so that occurrence of image defects such as image non-uniformity can be suppressed.

### BRIEF DESCRIPTION OF DRAWINGS

FIG. 1(a) is a sectional view showing an example of an electrophotographic photoreceptor, and FIG. 1(b) is a main part sectional view of FIG. 1(a);

FIG. 2 is a longitudinal sectional view of a deposited-film forming apparatus; and

FIG. 3 is a sectional view showing an example of an image forming apparatus.

### DESCRIPTION OF EMBODIMENTS

An example of embodiment of an electrophotographic photoreceptor of the invention and an image forming apparatus employing this is described below with reference to the drawings. Here, the following example merely illustrates an embodiment of the invention and hence the invention is not limited to the example of embodiment.

(Electrophotographic Photoreceptor)

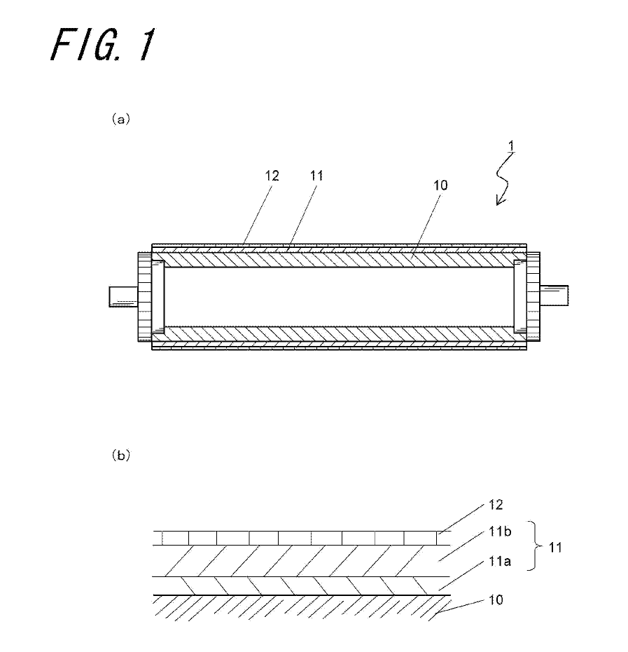

An electrophotographic photoreceptor 1 shown in FIG. 1 includes a photosensitive layer 11 in which a charge injection blocking layer 11a and a photoconductive layer 11b are successively formed on an outer peripheral surface of a cylindrical substrate 10. Then, a surface layer 12 is adhered onto the photosensitive layer 11.

The cylindrical substrate 10 serves as a supporting body for the photosensitive layer 11 and has an electrical conductivity at least in the surface. For example, employable materials for the cylindrical substrate 10 include: metallic materials such as aluminum (Al), zinc (Zn), copper (Cu), iron (Fe), titanium (Ti), nickel (Ni), chromium (Cr), tantalum (Ta), tin (Sn), gold (Au), and silver (Ag); and alloys such as stainless steel containing metallic materials. The cylindrical substrate 10 may be constructed such that an electrically conductive film fabricated from a metallic material described above or a transparent electrically conductive material such as ITO (Indium Tin Oxide) and SnO₂ is adhered to the surface of an insulating material such as resin, glass, and ceramic. As the cylindrical substrate 10, it is preferable that a material containing aluminum (Al) is employed. Further, it is more preferable that the entirety of the cylindrical substrate 10 is formed of a material containing aluminum (Al). By virtue of this, the electrophotographic photoreceptor 1 can be fabricated in a light weight at a low cost. Further, in a case where the charge injection blocking layer 11a and the photoconductive layer 11b are formed of an amorphous silicon (a-Si) based material, the adhesion property between those layers and the cylindrical substrate 10 is improved so that reliability is improved.

The charge injection blocking layer 11a blocks carriers (electrons) from being injected from the cylindrical substrate 10. As the charge injection blocking layer 11a, for example, an amorphous silicon (a-Si) based material is employed. The charge injection blocking layer 11a is formed, for example, as amorphous silicon (a-Si) containing boron (B), nitrogen (N), and oxygen (O) serving as dopants, and has a thickness of 2 μm or greater and 10 μm or smaller.

The photoconductive layer 11b generates carriers by light irradiation of laser light or the like. As the photoconductive layer 11b, for example, an amorphous silicon (a-Si) based material or an amorphous selenium (a-Se) based material such as Se—Te and As₂Se₃ is employed. The photoconductive layer 11b of the present embodiment is formed of amorphous silicon (a-Si) and an amorphous silicon (a-Si) based material obtained by adding carbon (C), nitrogen (N), oxygen (O), and the like to amorphous silicon (a-Si), and then contains boron (B) as a dopant.

Further, it is sufficient that the thickness of the photoconductive layer 11b is set up suitably in accordance with the employed photoconductivity material and desired electrophotographic properties. In a case where the photoconductive layer 11b is formed by employing an amorphous silicon (a-Si) based material, the thickness of the photoconductive layer 11b is set to be, for example, 5 μm or greater and 100 μm or smaller and, and preferably, 10 μm or greater and 80 μm or smaller.

The surface layer 12 protects the surface of the photosensitive layer 11. As the surface layer 12, amorphous carbon (a-C) is employed that has high resistance against wear caused by rubbing in the inside of the image forming apparatus.

In general, as a material for the surface layer, for example, an amorphous silicon (a-Si) based material such as amorphous silicon carbide (a-SiC) or amorphous silicon nitride (a-SiN) is adopted. From the perspective of satisfactory wear resistance, in the present embodiment, amorphous carbon (a-C) is adopted as the surface layer 12.

In order to avoid a situation that light such as laser light projected on the electrophotographic photoreceptor 1 is absorbed or reflected, it is preferable that the surface layer 12 has an excellent light transmissivity and further has a surface resistance value (of 10¹¹ Ω·cm or higher, in general) sufficient for holding of an electrostatic latent image in image formation. In some cases, amorphous carbon (a-C) does not have a higher light transmissivity and a higher surface resistance value in comparison with an amorphous silicon (a-Si) based material.

In a case where an electrophotographic photoreceptor 1 whose surface layer 12 does not have a high light transmissivity is used in a state of being incorporated in an image forming apparatus 100 described later, in some cases, the light irradiation amount at the time when the surface charge of the electrophotographic photoreceptor 1 is to be removed by a charge removing device 117 constituting the image forming apparatus 100 increases so that the charge removing load increases or, alternatively, the image density at the time when printing is performed by the image forming apparatus 100 becomes thin so that the sensitivity is degraded. Further, in a case where an electrophotographic photoreceptor 1 whose surface layer 12 does not have a high surface resistance value is used in a state of being incorporated in an image forming apparatus 100 described later, when printing is performed by the image forming apparatus 100, image deletion occurs or, alternatively, a high resolution cannot be obtained. Further, in a case where the wear resistance is excessively high, in some cases, remarkable wear occurs in a cleaning device 116 constituting the image forming apparatus 100.

In the surface layer 12 containing amorphous carbon, in order to increase the light transmissivity and the surface resistance value, a ratio (a D/G ration) of an integrated intensity of D band to an integrated intensity of G band in a Raman spectrum of the surface layer 12 is 0.86 or higher and 1.23 or lower. Here, the G band indicates a lattice band observed near a wave number of 1550 cm⁻¹ (e.g., 1500 to 1600 cm⁻¹) and the D band indicates a lattice band observed near a wave number of 1390 cm⁻¹ (e.g., 1340 to 1440 cm⁻¹). The G band is observed by the presence of amorphous carbon (a-C) of sp³ structure and the D band is observed by the presence of amorphous carbon (a-C) of sp² structure. That is, the ratio of the integrated intensity of D band to the integrated intensity of G band in the Raman spectrum of the surface layer 12 is recognized as a value having correlation with the ratio of the fraction of sp³ structure in the amorphous carbon of the surface layer 12 relative to the fraction of sp² structure.

In a case where the D/G ratio of the surface layer 12 is lower than 0.86, the wear resistance is unsatisfactory. Thus, when a printing test is repeated in a state of being incorporated in an image forming apparatus 100 described later, image density non-uniformity occurs before a predetermined number of sheets is reached. That is, a problem occurs like the surface layer of the electrophotographic photoreceptor 1 partly becomes excessively thin owing to wear or, alternatively, scratches are easily generated in the electrophotographic photoreceptor 1. Further, in a case where the D/G ratio of the surface layer 12 exceeds 1.23, the light transmissivity is poor. Thus, when initial evaluation is performed in a state of being incorporated in an image forming apparatus 100 described later, a problem occurs like the charge removing load becomes high, a high sensitivity is not obtained, image deletion occurs, or a high resolution is not obtained.

Here, in a case where measurement of the Raman spectrum of the surface layer 12 alone is difficult, it is sufficient that the measurement is performed on the electrophotographic photoreceptor 1.

Further, in a case where the light transmissivity or the surface resistance value is desired to be increased, it is sufficient that a ratio (an H/C ratio) of the number of hydrogen atoms to the number of carbon atoms per unit volume contained in the surface layer 12 is set to be 0.55 or higher and 0.7 or lower. As described in a formation method for a deposited film explained later, in formation of the surface layer 12, C₂H₂ (acetylene gas) or CH₄ (methane gas) is employed as raw material gas and thereby hydrogen atoms (H) are contained. In a case where the H/C ratio of the surface layer 12 is lower than 0.55, the light transmissivity is poor. Thus, when initial evaluation is performed in a state of being incorporated in an image forming apparatus 100 described later, in some cases, a problem occurs like the charge removing load becomes high, a high sensitivity is not obtained, or a high resolution is not obtained. In a case where the H/C ratio of the surface layer 12 exceeds 0.7, the wear resistance is poor. Thus, when a printing test is repeated in a state of being incorporated in an image forming apparatus 100 described later, in some cases, image density non-uniformity occurs before a predetermined number of sheets is reached. That is, a problem occurs like the surface layer of the electrophotographic photoreceptor 1 partly becomes excessively thin owing to wear or, alternatively, scratches are easily generated in the electrophotographic photoreceptor 1.

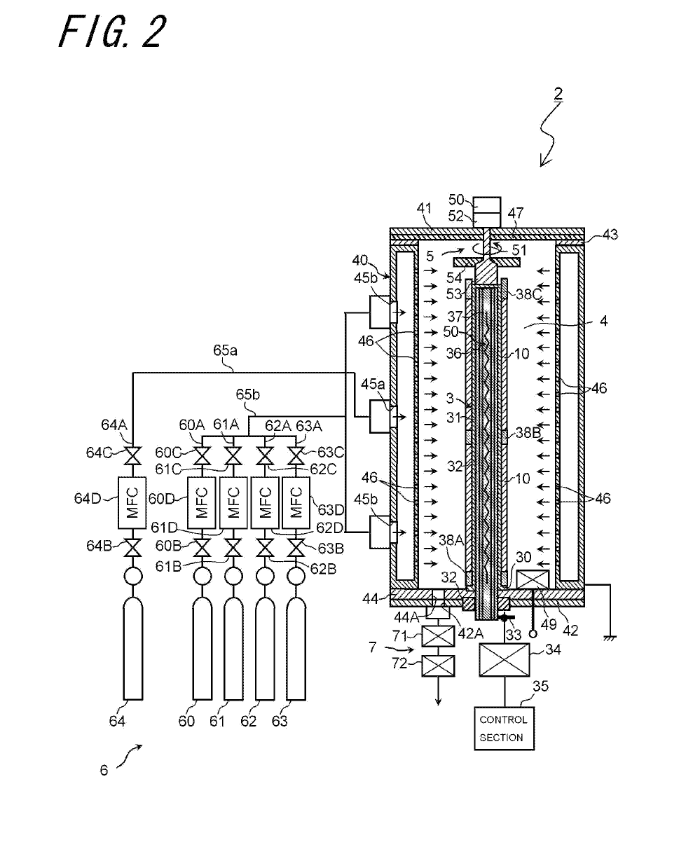

The charge injection blocking layer 11a, the photoconductive layer 11b, and the surface layer 12 in the electrophotographic photoreceptor 1 are formed, for example, by employing a plasma CVD apparatus 2 shown in FIG. 2.

(Plasma CVD Apparatus)

The plasma CVD apparatus 2 is constructed such that a supporting body 3 is accommodated in a vacuum reaction chamber 4, and further includes revolving means 5, raw material gas supply means 6, and evacuation means 7.

The supporting body 3 supports the cylindrical substrate 10. The supporting body 3 is formed in a hollow shape having a flange 30. Then, the entirety of the supporting body 3 is formed as a conductor made of an electrically conductive material similar to the cylindrical substrate 10. In the present embodiment, the supporting body 3 is formed in a length capable of supporting two cylindrical substrates 10 and is attachable and detachable relative to an electrically conductive supporting rod 31. Thus, by virtue of the supporting body 3, the two cylindrical substrates 10 can be inserted or removed relative to the vacuum reaction chamber 4 without directly touching the surface of the supported two cylindrical substrates 10.

The entirety of the electrically conductive supporting rod 31 is formed as a conductor made of an electrically conductive material similar to the cylindrical substrate 10. Then, in the center of the vacuum reaction chamber 4 (a cylindrical electrode 40 described later), the electrically conductive supporting rod 31 is fixed to a plate 42 described later via an insulating material 32. A direct-current power supply 34 is connected through an electrically conductive plate 33 to the electrically conductive supporting rod 31. The operation of the direct-current power supply 34 is controlled by a control section 35. The control section 35 is constructed such as to control the direct-current power supply 34 so as to supply a pulse-shaped direct-current voltage through the electrically conductive supporting rod 31 to the supporting body 3.

In the inside of the electrically conductive supporting rod 31, a heater 37 is accommodated via a ceramic pipe 36. The ceramic pipe 36 ensures insulation and thermal conductivity. The heater 37 heats the cylindrical substrate 10. As the heater 37, for example, a nichrome wire or a cartridge heater may be employed.

The temperature of the supporting body 3 is monitored, for example, by a thermocouple (not shown) attached to the supporting body 3 or the electrically conductive supporting rod 31. Then, on the basis of the monitored result from the thermocouple, the heater 37 is turned ON or OFF so that the temperature of the cylindrical substrate 10 is maintained within a target range like a fixed range selected, for example, from 200° C. or higher and 400° C. or lower.

The vacuum reaction chamber 4 is space used for forming a deposited film on the cylindrical substrate 10 and is defined by a cylindrical electrode 40 and a pair of plates 41 and 42.

The cylindrical electrode 40 is formed in a cylindrical shape surrounding the periphery of the supporting body 3. The cylindrical electrode 40 is formed in a hollow shape by employing an electrically conductive material similar to the cylindrical substrate 10 and is joined to the pair of plates 41 and 42 via insulating members 43 and 44.

The cylindrical electrode 40 is formed in such a size that the distance D1 between the cylindrical substrate 10 supported by the supporting body 3 and the cylindrical electrode 40 becomes 10 mm or greater and 100 mm or smaller. When the distance D1 is smaller than 10 mm, in some cases, workability cannot sufficiently be ensured at the time of insertion, removal, or the like of the cylindrical substrate 10 relative to the vacuum reaction chamber 4 or, alternatively, stable electric discharge between the cylindrical substrate 10 and the cylindrical electrode 40 becomes difficult to be obtained. When the distance D1 is greater than 100 mm, the plasma CVD apparatus 2 becomes large and hence the productivity per unit installation area is degraded in some cases.

The cylindrical electrode 40 is provided with gas introduction ports 45a and 45b and a plurality of gas blowout holes 46 and is grounded at one end thereof. The cylindrical electrode 40 need not indispensably be grounded and may be connected to a reference supply other than the direct-current power supply 34. In a case where the cylindrical electrode 40 is connected to a reference supply other than the direct-current power supply 34, the reference voltage in the reference supply is set to be −1500 V or higher and 1500 V or lower.

The gas introduction port 45a is provided for introducing raw material gas dedicated for dopants of the photoconductive layer 11b to be supplied to the vacuum reaction chamber 4. The gas introduction port 45b is provided for introducing raw material gas to be supplied to the vacuum reaction chamber 4. The gas introduction ports 45a and 45b are both connected to the raw material gas supply means 6. The gas introduction port 45a is installed at a substantially center height position of the vacuum reaction chamber 4. The gas introduction ports 45b are installed at height positions corresponding to both end positions of the supporting body 3 installed in the vacuum reaction chamber 4.

The plurality of gas blowout holes 46 are provided for blowing out toward the cylindrical substrate 10 the raw material gas introduced into the inside of the cylindrical electrode 40 and are arranged at equal intervals in the up and down directions in the figure and at equal intervals also in the circumferential direction. The plurality of gas blowout holes 46 are formed in circular shapes identical to each other. Each diameter of the gas blowout holes 46 is, for example, 0.5 mm or greater and 2 mm or smaller.

The plate 41 is provided for permitting selection between a state where the vacuum reaction chamber 4 is opened and a state where the vacuum reaction chamber 4 is closed. Then, when the plate 41 is opened and closed, insertion or removal of the supporting body 3 relative to the vacuum reaction chamber 4 is permitted. The plate 41 is formed of an electrically conductive material similar to the cylindrical substrate 10. Here, an adhesion-proof board 47 is attached to the lower face side. This avoids a situation that a deposited film is formed on the plate 41. The adhesion-proof board 47 is also formed of an electrically conductive material similar to the cylindrical substrate 10. Here, the adhesion-proof board 47 is fabricated such as to be attachable and detachable relative to the plate 41. Thus, when removed from the plate 41, the adhesion-proof board 47 can be cleaned so that repeated use is permitted.

The plate 42 serves as a base of the vacuum reaction chamber 4 and is formed of an electrically conductive material similar to the cylindrical substrate 10. The insulating member 44 interposed between the plate 42 and the cylindrical electrode 40 plays the role of suppressing occurrence of arc discharge between the cylindrical electrode 40 and the plate 42. The insulating member 44 is not limited to particular one as long as the material has an insulating property, a sufficient heat resistance at a usage temperature, and a low gas release in vacuum. For example, employable materials for the insulating member 44 include: glass materials (such as a borosilicate glass, a soda glass, and a heat-resistant glass); inorganic insulating materials (such as ceramic, quartz, and sapphire); and synthetic resin insulating materials (such as a fluororesin like tetrafluoroethylene, polycarbonate, polyethylene terephthalate, polyester, polyethylene, polypropylene, polystyrene, polyamide, vinylon, epoxy, Mylar, and a PEEK material). Here, from the perspective of suppressing occurrence of warpage caused by an internal stress in the formed film material or by a stress resulting from a bimetal effect generated with a temperature rise at the time of film formation, the insulating member 44 may have a thickness greater than or equal to a fixed value. For example, in a case where the insulating member 44 is formed of a material such as tetrafluoroethylene having a thermal expansion coefficient of 3×10⁻⁵/K or higher and 10×10⁵/K or lower, the thickness of the insulating member 44 is set to be 10 mm or greater. In a case where the thickness of the insulating member 44 is set to fall within such a range, the warpage amount resulting from a stress generated in the interface between the insulating member 44 and an amorphous silicon (a-Si) film of 10 μm or greater and 30 μm or smaller formed on the cylindrical substrate 10 can be made 1 mm or smaller in terms of a difference in the axial-directional height between an end portion and the center portion in the horizontal direction, per horizontal length of 200 mm (in a radial direction substantially perpendicular to the axial direction of the cylindrical substrate 10) and hence repeated use of the insulating member 44 is permitted.

The plate 42 and the insulating member 44 are provided with gas evacuation ports 42A and 44A and a pressure gage 49. The evacuation ports 42A and 44A are provided for evacuating the gas in the inside of the vacuum reaction chamber 4 and are connected to the evacuation means 7. The pressure gage 49 is provided for monitoring the pressure of the vacuum reaction chamber 4 and may be constructed from a device of diverse kind.

As shown in FIG. 2, the revolving means 5 is provided for revolving the supporting body 3 and includes a rotary motor 50 and a revolving force transmitting mechanism 51. When film formation is performed in a situation that the supporting body 3 is revolved by the revolving means 5, the cylindrical substrate 10 is revolved together with the supporting body 3 so that the decomposed component of the raw material gas can be deposited uniformly on the outer periphery of the cylindrical substrate 10.

The rotary motor 50 imparts a revolving force to the cylindrical substrate 10. The operation of the rotary motor 50 is controlled such as to revolve the cylindrical substrate 10, for example, at 1 rpm or higher and 10 rpm or lower. As the rotary motor 50, a device of diverse kind may be employed.

The revolving force transmitting mechanism 51 is provided for transmitting and inputting the revolving force from the rotary motor 50 to the cylindrical substrate 10 and includes a revolution introduction terminal 52, an insulating shaft member 53, and an insulating flat plate 54.

The revolution introduction terminal 52 is provided for transmitting the revolving force in a state where the vacuum in the vacuum reaction chamber 4 is maintained. As such a revolution introduction terminal 52, vacuum seal means such as an oil seal and a mechanical seal may be employed whose revolving shaft has a duplex or a triplex structure.

The insulating shaft member 53 and the insulating flat plate 54 are provided for inputting the revolving force from the rotary motor 50 to the supporting body 3 in a state where an insulated state between the supporting body 3 and the plate 41 is maintained, and are formed of an insulating material similar to the insulating member 44 or the like. Here, the outer diameter D2 of the insulating shaft member 53 is set such as to become smaller than the outer diameter (the inner diameter of an upper dummy substrate 38C described later) D3 of the supporting body 3 at the time of film formation. More specifically, in a case where the temperature of the cylindrical substrate 10 at the time of film formation is set to be 200° C. or higher and 400° C. or lower, the outer diameter D2 of the insulating shaft member 53 is set such as to become larger than the outer diameter D3 of the supporting body 3 (the inner diameter of an upper dummy substrate 38C described later) by an amount of 0.1 mm or greater and 5 mm or smaller and, preferably, by about 3 mm. In order that this condition may be satisfied, at the time of non-film formation (under ordinary temperature environment (e.g., 10° C. or higher and 40° C. or lower)), the difference between the outer diameter D2 of the insulating shaft member 53 and the outer diameter D3 of the supporting body 3 (the inner diameter of an upper dummy substrate 38C described later) is set to be 0.6 mm or greater and 5.5 mm or smaller.

The insulating flat plate 54 is provided for avoiding a situation that foreign substances such as dust and particulates falling from an upper part at the time of removing the plate 41 adhere to the cylindrical substrate 10, and has an outer diameter D4 larger than the inner diameter D3 of the upper dummy substrate 38C and is formed in a disk shape. The diameter D4 of the insulating flat plate 54 is set to be 1.5 times or greater and 3 times or smaller of the diameter D3 of the cylindrical substrate 10. Thus, for example, when the diameter D3 is 30 mm, the diameter D4 is about 50 mm.

In a case where such a insulating flat plate 54 is provided, abnormal electric discharge can be suppressed that could result from foreign substances having adhered to the cylindrical substrate 10. Thus, occurrence of film formation defects can be suppressed. By virtue of this, the production yield at the time of forming the electrophotographic photoreceptor 1 can be improved and occurrence of a defective image can be suppressed at the time of image formation performed by employing the electrophotographic photoreceptor 1.

As shown in FIG. 2, the raw material gas supply means 6 includes: a plurality of raw material gas cylinders 60, 61, 62, and 63; a gas cylinder 64 dedicated for dopants of the photoconductive layer 11b; a plurality of pipes 60A, 61A, 62A, 63A, and 64A; valves 60B, 61B, 62B, 63B, 64B, 60C, 61C, 62C, 63C, and 64C; and a plurality of mass flow controllers 60D, 61D, 62D, 63D, and 64D, and is connected through pipes 65a and 65b and the gas introduction ports 45a and 45b to the cylindrical electrode 40. Each of the raw material gas cylinders 60 to 64 is charged, for example, with B₂H₆, H₂ (or He), CH₄, or SiH₄. The valves 60B to 64B and 60C to 64C and the mass flow controllers 60D to 64D adjust the flow rate, the composition, and the gas pressure of each raw material gas component introduced into the vacuum reaction chamber 4 or the gas component dedicated for dopants of the photoconductive layer 11b. In the raw material gas supply means 6, it is sufficient that the kind of gas to be charged into each of the raw material gas cylinders 60 to 64 or the number of the plurality of raw material tanks 60 to 64 is selected suitably in accordance with the kind or the composition of the film to be formed on the cylindrical substrate 10.

The evacuation means 7 is provided for evacuating the gas in the vacuum reaction chamber 4 through the gas evacuation ports 42A and 44A to the outside and includes a mechanical booster pump 71 and a rotary pump 72. The operation of these pumps 71 and 72 is controlled in accordance with the monitoring result of the pressure gage 49. That is, in the evacuation means 7, on the basis of the monitoring result of the pressure gage 49, the vacuum reaction chamber 4 can be maintained at vacuum and, at the same time, the gas pressure of the vacuum reaction chamber 4 can be set to be a target value. For example, the pressure of the vacuum reaction chamber 4 is set to be 1 Pa or higher and 100 Pa or lower.

(Method for Forming Deposited Film)

Next, a method for forming a deposited film by using the plasma CVD apparatus 2 is described below for an exemplary case where the electrophotographic photoreceptor 1 (see FIG. 1) is fabricated in which an amorphous silicon (a-Si) film serving as the photosensitive layer 11 and amorphous carbon (a-C) serving as the surface layer 12 are formed on the cylindrical substrate 10.

First, when a deposited film (a-Si film) is to be formed on the cylindrical substrate 10, the plate 41 of the plasma CVD apparatus 2 is removed, then the supporting body 3 supporting a plurality (two in the figure) of cylindrical substrates 10 is set up in the inside of the vacuum reaction chamber 4, and then the plate 41 is attached again.

In supporting of the two cylindrical substrates 10 on the supporting body 3, a lower dummy substrate 38A, a cylindrical substrate 10, an intermediate dummy substrate 38B, a cylindrical substrate 10, and an upper dummy substrate 38C are successively stacked on the flange 30 such as to cover the main portion of the supporting body 3.

As each of the dummy substrates 38A to 38C, one constructed such that electric conduction processing is performed on the surface of an electrically conductive or an insulating substrate is selected in accordance with the application of the product. However, in ordinary cases, one formed in a cylindrical shape from a material similar to the cylindrical substrate 10 is employed.

Here, the lower dummy substrate 38A adjusts the height position of the cylindrical substrate 10. The intermediate dummy substrate 38B suppresses occurrence of defective film formation in the cylindrical substrate 10 caused by arc discharge generated between the adjacent end portions of the cylindrical substrates 10. As the intermediate dummy substrate 38B, a material is employed that has a length greater than or equal to a minimal length (1 cm in the present embodiment) capable of avoiding arc discharge and has front-face side corners chamfered such that the curvature becomes 0.5 mm or greater by curved surface machining or, alternatively, such that the length in the axial direction and the length in the depth direction of a portion cut by end face machining become 0.5 mm or greater. The upper dummy substrate 38C is used for suppressing formation of a deposited film on the supporting body 3 and suppressing occurrence of defective film formation caused by peeling of a formed film material once having adhered during film formation. The upper dummy substrate 38C is in a state where a part protrudes above the supporting body 3.

Then, the vacuum reaction chamber 4 is put in a tightly sealed state. Then, the cylindrical substrate 10 is revolved through the supporting body 3 by the revolving means 5 and, at the same time, the cylindrical substrate 10 is heated and the vacuum reaction chamber 4 is pressure-reduced by the evacuation means 7.

Heating of the cylindrical substrate 10 is performed, for example, by supplying electric power from the outside to the heater 37 so that the heater 37 is caused to generate heat. By virtue of such heat generation of the heater 37, the temperature of the cylindrical substrate 10 is raised to a target temperature. The temperature of the cylindrical substrate 10 is selected in accordance with the kind and the composition of the film to be formed on the surface. For example, when an amorphous silicon (a-Si) film is to be formed, the temperature is set to fall within a range of 250° C. or higher and 300° C. or lower. Then, the heater 37 is turned ON or OFF so that the temperature is maintained substantially at constant.

On the other hand, pressure reduction of the vacuum reaction chamber 4 is performed by evacuating the gas from the vacuum reaction chamber 4 through the gas evacuation ports 42A and 44A by using the evacuation means 7. For example, the level of pressure reduction in the vacuum reaction chamber 4 is about 10⁻³ Pa, which is achieved by controlling the operation of the mechanical booster pump 71 (see FIG. 2) and the rotary pump 72 (see FIG. 2) with monitoring the pressure of the vacuum reaction chamber 4 indicated by the pressure gage 49 (see FIG. 2).

Then, when the temperature of the cylindrical substrate 10 has reached a desired temperature and the pressure of the vacuum reaction chamber 4 has reached a desire pressure, raw material gas is supplied to the vacuum reaction chamber 4 by the raw material gas supply means 6 and, at the same time, a pulse-shaped direct-current voltage is applied between the cylindrical electrode 40 and the supporting body 3. By virtue of this, glow discharge occurs between the cylindrical electrode 40 and the supporting body 3 (the cylindrical substrate 10) so that the raw material gas component is decomposed and the decomposed component of the raw material gas is deposited on the surface of the cylindrical substrate 10.

On the other hand, with monitoring the pressure gage 49, the evacuation means 7 controls the operation of the mechanical booster pump 71 and the rotary pump 72 so as to maintain the gas pressure in the vacuum reaction chamber 4 within a target range. That is, the inside of the vacuum reaction chamber 4 is maintained at a stable gas pressure by using the mass flow controllers 60D to 63D in the raw material gas supply means 6 and the pumps 71 and 72 in the evacuation means 7. For example, the gas pressure in the vacuum reaction chamber 4 is set to be 1 Pa or higher and 100 Pa or lower.

Supply of the raw material gas to the vacuum reaction chamber 4 is performed by controlling the mass flow controllers 60D to 64D with suitably controlling the open and close states of the valves 60B to 64B and 60C to 64C so that the raw material gases of the raw material gas cylinders 60 to 64 are introduced through the pipes 60A to 64A, 65a, and 65b and the gas introduction ports 45a and 45b into the inside of the cylindrical electrode 40 at a desired composition and a flow rate. The raw material gas introduced into the inside of the cylindrical electrode 40 is blown out through the plurality of gas blowout holes 46 toward the cylindrical substrate 10. Then, when the composition of the raw material gas is suitably switched by the valves 60B to 64B and 60C to 64C and the mass flow controllers 60D to 64D, the charge injection blocking layer 11, the photoconductive layer 11b, and the surface layer 12 are successively formed and stacked on the surface of the cylindrical substrate 10.

Application of the pulse-shaped direct-current voltage between the cylindrical electrode 40 and the supporting body 3 is performed by controlling the direct-current power supply 34 by means of the control section 35.

In general, in a case where high-frequency electric power of RF band of 13.56 MHz or higher is employed, ionic species generated in the space are accelerated by the electric field and thereby attracted in directions corresponding to the positive and negative polarities. Here, since the electric field is successively reversed in accordance with the high-frequency alternating current, before reaching the cylindrical substrate 10 or the discharge electrode, the ionic species repeat recombination in the space so as to become gas or a silicon compound such as polysilicon powder again and then are evacuated.

In contrast, in a case where a pulse-shaped direct-current voltage in which either positive or negative polarity is generated on the cylindrical substrate 10 side is applied so as to accelerate and cause the cations to collide with the cylindrical substrate 10 and then film formation of amorphous silicon (a-Si) is performed with performing sputtering on minute depressions and protrusions in the surface by utilizing the impact thereof, amorphous silicon (a-Si) whose surface has only a remarkably small number of depressions and protrusions is obtained. In the present specification, this phenomenon is referred to as an “ion sputtering effect”.

In order to efficiently obtain the ion sputtering effect in such a plasma CVD method, it is necessary to apply electric power such as to avoid successive polarity reversal. Thus, in addition to the pulse-shaped rectangular wave described above, a triangular wave and a direct-current voltage whose polarity is not reversed are useful. Further, a similar effect is obtained also in an alternating voltage or the like whose entire voltage is adjusted such as to become either positive or negative polarity. The polarity of the applied voltage may be adjusted arbitrarily with taking into consideration the film formation rate determined from the density of ionic species, the polarity of deposited species, and the like depending on the kind of raw material gas.

Here, in order to efficiently obtain the ion sputtering effect by employing a pulse-shaped voltage, the electric potential difference between the supporting body 3 (the cylindrical substrate 10) and the cylindrical electrode 40 is set to fall, for example, within a range of 50 V or higher and 3000 V or lower. When the film formation rate is taken into consideration, preferably, the value is set to fall within a range of 500 V or higher and 3000 V or lower.

More specifically, when the cylindrical electrode 40 is grounded, the control section 35 supplies to the supporting body (the electrically conductive supporting rod 31) a negative pulse-shaped direct-current electric potential V1 falling within a region of −3000 V or higher and −50 V or lower or, alternatively, supplies a positive pulse-shaped direct-current electric potential V1 falling within a range of 50 V or higher and 3000 V or lower.

On the other hand, in a case where the cylindrical electrode 40 is connected to a reference electrode (not shown), the pulse-shaped direct-current electric potential V1 to be supplied to the supporting body (the electrically conductive supporting rod 31) is set to be a value equal to the difference (ΔV−V2) between a target electric potential difference ΔV and an electric potential V2 supplied from the reference supply. When a negative pulse-shaped voltage is to be applied to the supporting body 3 (the cylindrical substrate 10), the electric potential V2 supplied from the reference supply is set to be −1500 V or higher and 1500 V or lower. When a positive pulse-shaped voltage is to be applied to the supporting body 3 (the cylindrical substrate 10), the electric potential is set to be −1500 V or higher and 1500 V or lower.

The control section 35 further controls the direct-current power supply 34 such that the frequency (1/T (sec)) of the direct-current voltage becomes 300 kHz or lower and the duty ratio (T1/T) becomes 20% or higher and 90% or lower.

Here, the duty ratio in the invention is defined as the fraction of time T1 of generation of the electric potential difference within one period (T) of the pulse-shaped direct-current voltage (the time from the moment when the electric potential difference is generated between the cylindrical substrate 10 and the cylindrical electrode 40 to the next moment when the electric potential difference is generated). For example, a duty ratio of 20% indicates that the time of generation (ON) of the electric potential difference occupying within one period is 20% of the entire one period at the time of applying of the pulse-shaped voltage.

In the photoconductive layer 11b of amorphous silicon (a-Si) obtained by utilizing the ion sputtering effect, even when the thickness becomes 10 μm or greater, minute depressions and protrusions in the surface are small and hence the smoothness is hardly lost. Thus, the surface shape of the surface layer 12 in a case where amorphous carbon (a-C) serving as the surface layer 12 is stacked on the photoconductive layer 11b by about 1 μm can be a smooth surface reflecting the surface shape of the photoconductive layer 11b. On the other hand, even at the time of stacking the surface layer 12, when the ion sputtering effect is utilized, the surface layer 12 can be formed as a smooth film whose minute depressions and protrusions are small.

Here, at the time of formation of the charge injection blocking layer 11, the photoconductive layer 11b, and the surface layer 12, as described above, the mass flow controllers 60D to 63D and the valves 60B to 63B and 60C to 63C in the raw material gas supply means 6 are controlled so that the raw material gas of target composition is supplied to the vacuum reaction chamber 4.

For example, in a case where the charge injection blocking layer 11 is to be formed as a deposited film of amorphous silicon (a-Si) based material, a mixed gas composed of a silicon (Si) containing gas such as SiH₄ (silane gas), a dopant containing gas such as B₂H₆, and a dilution gas such as hydrogen (H₂) and helium (He) is employed as the raw material gas. As the dopant containing gas, in addition to a boron (B) containing gas, a nitrogen (N) and oxygen (O) containing gas may be employed.

In a case where the photoconductive layer 11b is formed as a deposited film of amorphous silicon (a-Si) based material, a mixed gas composed of a silicon (Si) containing gas such as SiH₄ (silane gas) and a dilution gas such as hydrogen (H₂) and helium (He) is employed as the raw material gas. In the photoconductive layer 11b, in order that hydrogen (H) or a halogen element (F or Cl) may be contained in the film by 1 atom % or higher and 40 atom % or lower for the purpose of dangling bond termination, hydrogen gas may be employed as the dilution gas or, alternatively, a halogenated compound may be contained in the raw material gas. Further, for the purpose of obtaining desired characteristics in the electrical properties such as dark conductivity and photoconductivity and in the optical band gap or the like, in the raw material gas, a twelfth or thirteenth group element in the periodic table (abbreviated as a “twelfth group element” or a “thirteenth group element”, hereinafter) or, alternatively, a fifteenth or sixteenth group element in the periodic table (abbreviates as a “fifteenth group element” or a “sixteenth group element”, hereinafter) may be contained as the dopant and then an element such as carbon (C) and oxygen (O) may be contained for the purpose of adjusting the above-mentioned characteristics.

For example, as the thirteenth and the fifteenth group element, boron (B) and phosphorus (P) are preferable in the point of having an excellent covalent bonding property and sensitively changeable semiconductor characteristics and in the point of excellent photo sensitivity. In a case where a thirteenth or fifteenth group element together with an element such as carbon (C) and oxygen (O) is to be contained in the charge injection blocking layer 11, the content of the thirteenth group element is adjusted into 0.1 ppm or higher and 20000 ppm or lower and the content of the fifteenth group element is adjusted into 0.1 ppm or higher and 10000 ppm or lower. Further, in a case where a thirteenth or fifteenth group element together with an element such as carbon (C) and oxygen (O) is to be contained in the photoconductive layer 11b or, alternatively, in a case where an element such as carbon (C) and oxygen (O) is not to be contained in the charge injection blocking layer 11a and the photoconductive layer 11b, the thirteenth group element is adjusted into 0.01 ppm or higher and 200 ppm or lower and the fifteenth group element is adjusted into 0.01 ppm or higher and 100 ppm or lower. Here, the content of the thirteenth group element or the fifteenth group element in the raw material gas may be changed temporally so that gradient in the thickness direction may be provided in the concentration of the element. In this case, as for the content of the thirteenth group element or the fifteenth group element in the photoconductive layer 11b, it is sufficient that the average content over the entirety of the photoconductive layer 11b falls within the range described above.

Further, in the photoconductive layer 11b, microcrystal silicon (μc-Si) may be contained in the amorphous silicon (a-Si) based material. Then, in a case where the microcrystal silicon (μc-Si) is contained, the dark conductivity and the photoconductivity can be increased and hence an advantage is obtained that the design flexibility for the photoconductive layer 22 increases. Such microcrystal silicon (μc-Si) can be formed by adopting the film formation method described above and changing the film formation condition. For example, in a glow discharge decomposition method, the temperature of the cylindrical substrate 10 and the direct-current pulse power are set somewhat high and then the flow rate of hydrogen serving as the dilution gas is set increased so that formation can be performed. Further, also in the photoconductive layer 11b containing microcrystal silicon (μc-Si), an element similar to those described above (a thirteenth group element, a fifteenth group element, carbon (C), oxygen (O), and the like) may be added.

The surface layer 12 is formed as an a-C layer as described above. In this case, a C-containing gas such as C₂H₂ (acetylene gas) and CH₄ (methane gas) is employed as the raw material gas. Further, the film thickness of the surface layer 12 is set usually to be 0.1 μm or greater and 2 μm or smaller, preferably to be 0.2 μm or greater and 1 μm or smaller, and optimally to be 0.3 μm or greater and 0.8 μm or smaller.

In a case where the surface layer 12 is formed as an a-C layer, since the C—O bond has a lower binding energy than the Si—O bond, oxidization in the surface of the surface layer 12 can be suppressed more reliably in comparison with a case where the surface layer 12 is formed of an amorphous silicon (a-Si) based material. Thus, in a case where the surface layer 12 is formed as an amorphous carbon (a-C) layer, a situation is appropriately suppressed that the surface of the surface layer 12 is oxidized by ozone or the like generated by corona discharge at the time of printing. Thus, occurrence of image deletion under environment of high temperature and high humidity or the like can be suppressed.

When film formation onto the cylindrical substrate 10 has been completed, the cylindrical substrate 10 is extracted from the supporting body 3 so that the electrophotographic photoreceptor 1 shown in FIG. 1 can be obtained. Then, after the film formation, for the purpose of removing film formation residual substances, the individual members in the inside of the vacuum reaction chamber 4 are disassembled and cleaned by using acid, alkali, or blast and then wet etching is performed such that dust generation causing a defect or inferiority in the next film formation may be avoided. Further, in place of the wet etching, it is effective to perform gas etching by employing a halogen based gas (ClF3, CF4, NF3, SiF6, or a mixed gas of these).

(Image Forming Apparatus)

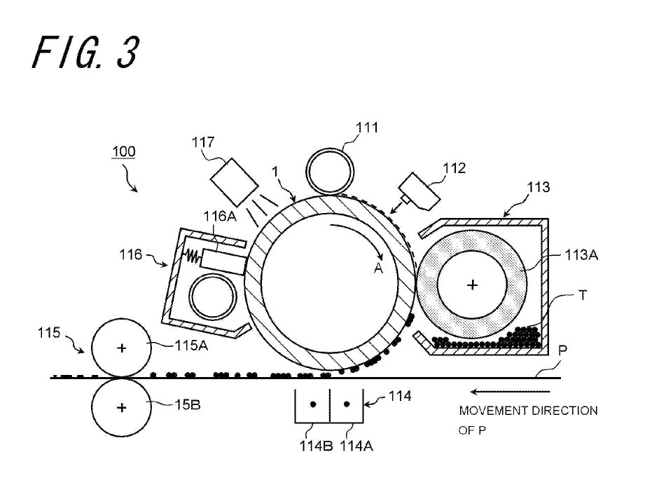

The image forming apparatus shown in FIG. 3 employs the Carlson method as an image formation method, and includes an electrophotographic photoreceptor 1, a charging device 111, an exposure device 112, a developing device 113, a transfer device 114, a fixing device 115, a cleaning device 116, and a charge removing device 117.

The charging device 111 plays the role of electrostatically charging into a negative polarity the surface of the electrophotographic photoreceptor 1. For example, the electrostatic charging voltage is set to be 200 V or higher and 1000 V or lower. In the present embodiment, for example, a contact type charging device constructed such that a core metal is covered by electrically conductive rubber or PVDF (polyvinylidene fluoride) is adopted as the charging device 111. However, in place of this, a non-contact type charging device (e.g., a corona charging device) provided with a discharge wire may be adopted.

The exposure device 112 plays the role of forming an electrostatic latent image in the electrophotographic photoreceptor 1. Specifically, in the exposure device 112, in accordance with an image signal, exposing light (e.g., laser light) of particular wavelength (e.g., 650 nm or greater and 780 nm or smaller) is projected on the electrophotographic photoreceptor 1 and thereby the electric potential of the exposing-light irradiated portion of the electrophotographic photoreceptor 1 in an electrostatically charged state is attenuated so that an electrostatic latent image is formed. As the exposure device 112, for example, an LED head may be employed that is constructed by aligning a plurality of LED elements (wavelength: 680 nm).

Obviously, in place of the LED element, a device capable of emitting laser light may be employed as the light source of the exposure device 112. That is, in place of the exposure device 112 such as the LED head, an optical system including a polygon mirror may be employed. Alternatively, an optical system including a lens and a mirror for passing the reflected light from the manuscript may be adopted so that an image forming apparatus of copying machine configuration may be constructed.

The developing device 113 plays the role of developing the electrostatic latent image on the electrophotographic photoreceptor 1 so as to form a toner image. The developing device 113 in the present embodiment includes a magnetic roller 113A for magnetically retaining a developer (toner) T.

The developer T constructs a toner image formed on the surface of the electrophotographic photoreceptor 1 and is triboelectrically charged in the developing device 113. For example, an employable developer T includes: two-component type developer containing magnetic carrier and insulating toner; and one-component type developer containing magnetic toner.

The magnetic roller 113A plays the role of conveying the developer onto the surface (the developing area) of the electrophotographic photoreceptor 1. The magnetic roller 113A conveys the developer T triboelectrically charged in the developing device 113, in the form of a magnetic brush adjusted into a fixed ear length. In the developing area of the electrophotographic photoreceptor 1, the developer T having been conveyed adheres to the surface of the electrophotographic photoreceptor 1 by virtue of electrostatic attraction by the electrostatic latent image and thereby forms a toner image (visualizes the electrostatic latent image). In a case where image formation is performed by charged area development, the polarity of electrostatic charging of the toner image is set reverse to the polarity of electrostatic charging of the surface of the electrophotographic photoreceptor 1. In a case where image formation is performed by discharged area development, the polarity of electrostatic charging of the toner image is set equal to the polarity of electrostatic charging of the surface of the electrophotographic photoreceptor 1.

Here, the developing device 113 in the present embodiment adopts a dry developing method. Instead, a wet developing method employing a liquid developer may be adopted.

The transfer device 114 plays the role of transferring the toner image formed in the electrophotographic photoreceptor 1, to a recording medium P supplied to the transfer region between the electrophotographic photoreceptor 1 and the transfer device 114. The transfer device 114 in the present embodiment includes a transfer charger 114A and a separation charger 114B. In the transfer device 114, the rear face (the non-recording surface) of the recording medium P is electrostatically charged into a polarity reverse to the toner image by the transfer charger 114A. Then, the toner image is transferred onto the recording medium P by virtue of electrostatic attraction between this electric charge of electrostatic charging and the toner image. Further, in the transfer device 114, at the same time as the transfer of the toner image, the rear face of the recording medium P is alternating-current charged by the separation charger 114B so that the recording medium P is rapidly separated from the surface of the electrophotographic photoreceptor 1.

As the transfer device 114, a transfer roller may be employed that follows the revolution of the electrophotographic photoreceptor 1 and is arranged with a minute gap (usually, 0.5 mm or smaller) relative to the electrophotographic photoreceptor 1. The transfer roller is constructed such as to apply a transfer voltage attracting the toner image formed on the electrophotographic photoreceptor 1, onto the recording medium P by means of, for example, a direct-current power supply. In a case where the transfer roller is employed, a transfer and separation device such as the separation charger 114B may be omitted.

The fixing device 115 plays the role of fixing onto the recording medium P the toner image transferred on the recording medium P, and includes a pair of fixing rollers 115A and 115B. For example, the fixing rollers 115A and 115B are constructed such that the surfaces of metallic rollers are coated with tetrafluoroethylene or the like. In the fixing device 115, heat, pressure, or the like is exerted on the recording medium P passing between the pair of fixing rollers 115A and 115B so that the toner image can be fixed onto the recording medium P.

The cleaning device 116 plays the role of removing toner remaining on the surface of the electrophotographic photoreceptor 1, and includes a cleaning blade 116A. The cleaning blade 116A plays the role of scraping residual toner from the surface of the electrophotographic photoreceptor 1. For example, the cleaning blade 116A is formed of a rubber material composed mainly of polyurthane resin.

The charge removing device 117 plays the role of removing the surface charge of the electrophotographic photoreceptor 1 and can emit light of particular wavelength (e.g., 780 nm or greater). The charge removing device 117 is constructed such that light is projected on the entirety of the axial direction of the surface of the electrophotographic photoreceptor 1 by a light source such as an LED so that the surface charge (a remaining electrostatic latent image) of the electrophotographic photoreceptor 1 is removed.

In the image forming apparatus 100 of the present embodiment, the above-mentioned effect of the electrophotographic photoreceptor 1 can be obtained.

### Example 1

As the conductive substrate, a drawn-out pipe was prepared that was fabricated from aluminum alloy and had an outer diameter of 30 mm, a length of 359 mm, and a thickness of 1.5 mm. Here, the outer peripheral surface thereof was mirror-finished and washed.

The substrate was set up in a plasma CVD apparatus shown in FIG. 2. Then, according to the film formation condition in the above-mentioned embodiment, samples A, B, C, D, and E for the electrophotographic photoreceptor having different values to each other in the ratio (the D/G ratio) of the integrated intensity of D band to the integrated intensity of G band in the Raman spectrum of the surface layer were fabricated.

TABLE 1

| | | Sample | | | | |
|---|---|---|---|---|---|---|
| | | A | B | C | D | E |
| D/G ratio | | 1.31 | 1.23 | 1.06 | 0.86 | 0.7 |
| Initial | Charge removing load | Available | Good | Good | Excellent | Excellent |
| characteristics | Sensitivity | Available | Good | Good | Good | Excellent |
| | Image deletion | Poor | Good | Good | Excellent | Excellent |
| | Resolution | Available | Good | Good | Excellent | Excellent |
| Wear | Image density non-uniformity | Excellent | Excellent | Excellent | Good | Poor |
| resistance | Scratches in Photosensitive material | Excellent | Excellent | Excellent | Excellent | Good |

In Table 1, “Excellent” indicates a remarkably satisfactory result, “Good” indicates a satisfactory result, “Available” indicates no practical problem, and “Poor” indicates infeasibility.

Then, the fabricated electrophotographic photoreceptor was incorporated into an apparatus obtained by modification of a color composite machine TASKalfa 3550ci manufactured by KYOCERA Document Solutions Inc. Then, evaluation was performed on the charge removing load, the sensitivity, the image deletion, and the resolution adopted as the initial characteristics and on the image density non-uniformity and scratches in the photosensitive material (the electrophotographic photoreceptor) adopted as the wear resistance. Each electrophotographic photoreceptor was evaluated under ordinary environment (a room temperature of 23° C. and a relative humidity of 60%).

Evaluation of the charge removing load adopted as an initial characteristic was performed by measuring the light irradiation amount of the charge removing device necessary for attenuation of a predetermined surface charge of the electrophotographic photoreceptor into a predetermined electric potential.

As evaluation of scratches in the electrophotographic photoreceptor adopted as the wear resistance, the presence or absence of scratches in the electrophotographic photoreceptor surface was observed by using a magnifying glass (20-fold) after continuous printing of 100,000 sheets was performed under the above-mentioned ordinary environment.

Evaluation of the sensitivity, the image deletion, and the resolution adopted as initial characteristics and of the image density non-uniformity adopted as the wear resistance was performed by printing out a particular evaluation pattern and then evaluating the outputted image.

As for the initial characteristics, when the D/G ratio of the surface layer was 1.23 or lower, a remarkably satisfactory (Excellent) or a satisfactory (Good) result was obtained in every evaluation item.

As for the wear resistance, when the D/G ratio was 0.86 or higher, a remarkably satisfactory (Excellent) or a satisfactory (Good) result was obtained in every evaluation item.

### Example 2

As the conductive substrate, a drawn-out pipe was prepared that was fabricated from aluminum alloy and had an outer diameter of 30 mm, a length of 359 mm, and a thickness of 1.5 mm. Here, the outer peripheral surface thereof was mirror-finished and washed.

The substrate was set up in a plasma CVD apparatus shown in FIG. 2. Then, according to the film formation condition in the embodiment given above, samples F,G,H,I, and J for the electrophotographic photoreceptor having different values to each other in the ratio (the H/C ratio) of the number of hydrogen atoms to the number of carbon atoms per unit volume of the surface layer were fabricated.

TABLE 2

| | | Sample | | | | |
|---|---|---|---|---|---|---|
| | | F | G | H | I | J |
| H/C ratio | | 0.45 | 0.55 | 0.63 | 0.7 | 0.75 |
| Initial | Charge removing load | Available | Good | Good | Excellent | Excellent |
| characteristics | Sensitivity | Available | Good | Good | Good | Excellent |
| | Image deletion | Poor | Good | Good | Excellent | Excellent |
| Wear | Image density non-uniformity | Excellent | Excellent | Excellent | Good | Poor |
| resistance | Scratches in photosensitive material | Excellent | Excellent | Excellent | Excellent | Available |

In Table 2, “Excellent” indicates a remarkably satisfactory result, “Good” indicates a satisfactory result, “Available” indicates no practical problem, and “Poor” indicates infeasibility.

Then, the fabricated electrophotographic photoreceptor was incorporated into an apparatus obtained by modification of a color composite machine TASKalfa 3550ci manufactured by KYOCERA Document Solutions Inc. Then, evaluation was performed on the charge removing load, the sensitivity, the image deletion, and the residual electrostatic charging adopted as the initial characteristics and on the image density non-uniformity and scratches in the photosensitive material (the electrophotographic photoreceptor) adopted as the wear resistance. Each electrophotographic photoreceptor was evaluated under ordinary environment (a room temperature of 23° C. and a relative humidity of 60%).

Evaluation of the charge removing load adopted as an initial characteristic was performed by measuring the light irradiation amount of the charge removing device necessary for attenuation of a predetermined surface charge of the electrophotographic photoreceptor into a predetermined electric potential.

As evaluation of scratches in the electrophotographic photoreceptor adopted as the wear resistance, the presence or absence of scratches in the electrophotographic photoreceptor surface was observed by using a magnifying glass (20-fold) after continuous printing of 100,000 sheets was performed under the above-mentioned ordinary environment.

Evaluation of the sensitivity and the image deletion adopted as initial characteristics and of the image density non-uniformity adopted as the wear resistance was performed by printing out a particular evaluation pattern and then evaluating the outputted image.

As for the initial characteristics, when the H/C ratio of the surface layer was 0.55 or higher, a remarkably satisfactory (Excellent) or a satisfactory (Good) result was obtained in every evaluation item.

As for the wear resistance, when the H/C ratio of the surface layer was 0.7 or lower, a remarkably satisfactory (Excellent) or a satisfactory (Good) result was obtained in every evaluation item.

The present embodiment has been described above. However, it goes without saying that the invention is not limited only to that shown in the embodiment and that improvements and changes can be made without departing from the scope of the invention.

For example, the D/G ratio of the surface layer 12 may become higher in one end portion of the surface layer in the axial direction of the cylindrical substrate 10. The electrophotographic photoreceptor 1 is attached in a state where both ends thereof are fixed by flanges or the like. Then, in general, the attaching accuracy of one end portion is not severe and hence a gap is generated between the flange and the electrophotographic photoreceptor 1 so as to cause shakiness at the time of revolution in the image forming apparatus 100 or the like. As a result, film thickness reduction of the surface layer 12 is accelerated in one end portion of the electrophotographic photoreceptor 1 in comparison with the other portions owing to the contact with a charging roller or the like. Thus, when the D/G ratio of the surface layer 12 is set increased in the one end portion of the electrophotographic photoreceptor 1, the wear resistance is improved in comparison with the other portions. By virtue of this, the degree of wear of the surface layer 12 can be equalized over the entirety of the electrophotographic photoreceptor 1.

Here, the expression “increased in the one end portion of the electrophotographic photoreceptor 1” indicates that when the amount of wear is large in a predetermined region alone of the one end portion of the surface layer 12 in accordance with the status of the image forming apparatus 100 or the like, the D/G ratio in the predetermined region alone of the one end portion is set increased in comparison with the other portions. Further, the expression indicates that when the amount of wear of the surface layer 12 gradually increases from one end to the other end in the axial direction of the cylindrical substrate 10 of the electrophotographic photoreceptor 1, the D/G ratio is set gradually increased from the one end to the other end in the axial direction of the cylindrical substrate 10 of the surface layer 12. In short, it is sufficient that the D/G ratio in a portion where the amount of wear of the surface layer 12 is large is set increased in comparison with the other portions.

Further, the D/G ratio of the surface layer 12 may be high in the center portion of the surface layer 12 than in both end portions of the surface layer 12 in the axial direction of the cylindrical substrate 10.

As for the charging device 111 constituting the image forming apparatus 100, a corona charging device causes a high ozone generation rate. Thus, a charging roller causing a lower ozone generation rate is widely employed recently. Since the charging roller contacts the electrophotographic photoreceptor 1 and imparts electric charge to the electrophotographic photoreceptor 1, the charging roller is arranged such as to be pressed against the electrophotographic photoreceptor 1. However, there is a tendency that the force of pressing the charging roller against the electrophotographic photoreceptor 1 becomes smaller in the center portion than in both end portions of the electrophotographic photoreceptor. Thus, the surface electric potential becomes low in the center portion of the electrophotographic photoreceptor 1. Thus, the light transmissivity in the center portion of the electrophotographic photoreceptor 1 is set lower than in the both end portions of the electrophotographic photoreceptor 1 so that the image characteristics can be equalized over the entirety of the electrophotographic photoreceptor 1. The electric potential of the exposing-light irradiated portion of the electrophotographic photoreceptor 1 in an electrostatically charged state is attenuated so that an electrostatic latent image is formed. Then, the amount of attenuation of the electric potential necessary for attenuation into a predetermined electric potential is different between the center portion and both end portions of the electrophotographic photoreceptor 1. In the center portion where the surface electric potential is low from the beginning, the necessary amount of attenuation of the electric potential is smaller than in both end portions. Thus, when the irradiation amount of exposing light is reduced, the amount of attenuation of the electric potential can be adjusted so that equalization of the image characteristics in the center portion and both end portions of the electrophotographic photoreceptor 1 can be achieved. In order to reduce the irradiation amount of exposing light, the D/G ratio of the surface layer 12 is set increased.

Here, as for fluctuation in the surface electric potential of the electrophotographic photoreceptor 1 caused by fluctuation in the amount of electric charge imparted to the electrophotographic photoreceptor 1 by the charging roller, there are various examples in addition to the examples given above.

For example, depending on the formation method for the charging roller, in some cases, the amount of electrostatic charging gradually increases from one end of the charging roller toward the other end. Further, in a case where with taking in consideration the above-mentioned situation, the charging roller is formed in a so-called taper crown shape or a radial crown (a barrel crown) shape in which the diameter becomes large in the center portion, in contrast to the example given above, in some cases, the surface electric potential becomes lower in both end portions of the electrophotographic photoreceptor 1 than in the center portion. In such a case, the D/G ratio is set increased in order to reduce the light transmissivity of the surface layer 12 in the portion where the surface electric potential is low.

Here, the photosensitive layer 11 of the present embodiment has been an inorganic photosensitive material formed of an amorphous silicon (a-Si) based material. Instead, an organic photosensitive material may be employed.

### REFERENCE SIGNS LIST

1: Electrophotographic photoreceptor
10: Cylindrical substrate
11: Photosensitive layer
11a: Charge injection blocking layer
11b: Photoconductive layer
12: Surface layer
100: Image forming apparatus
111: Charging device
112: Exposure device
113: Developing device
114: Transfer device
115: Fixing device
116: Cleaning device
117: Charge removing device

1. An electrophotographic photoreceptor, comprising:
a cylindrical substrate;
a photosensitive layer formed on the cylindrical substrate, the photosensitive layer comprising at least a photoconductive layer; and
a surface layer formed on the photosensitive layer,
wherein the surface layer contains amorphous carbon, and has a ratio of an integrated intensity of D band to an integrated intensity of G band in a Raman spectrum of the surface layer being 0.86 or higher and 1.23 or lower.

2. The electrophotographic photoreceptor according to claim 1, wherein the surface layer further contains hydrogen, and has a ratio of a number of hydrogen atoms to a number of carbon atoms per unit volume of the surface layer being 0.55 or higher and 0.7 or lower.

3. The electrophotographic photoreceptor according to claim 1, wherein the ratio of the integrated intensity of D band to the integrated intensity of G band in the Raman spectrum of the surface layer is higher in one end portion of the surface layer in an axial direction of the cylindrical substrate.

4. The electrophotographic photoreceptor according to claim 1, wherein the ratio of the integrated intensity of D band to the integrated intensity of G band in the Raman spectrum of the surface layer is higher in a center portion of the surface layer in an axial direction of the cylindrical substrate than in both end portions of the surface layer in the axial direction of the cylindrical substrate.

5. An image forming apparatus, comprising:
the electrophotographic photoreceptor according to claim 1.
